(19) United States
(12) Patent Application Publication
(10) Pub. No.: US 2007/0183037 A1
(43) Pub. Date: Aug. 9, 2007

(54) Mirror with built-in-display

(75) Inventors: Dirk Kornelis Gerhardus De Boer, Eindhoven (NL); Armanda Cinderella Nieuwkerk, Eindhoven (NL); Hugo Johan Cornelissen, Eindhoven (NL); Jan Baptist Adrianus Maria Horsten, Eindhoven (NL); Martinus Hermanus Wilhelmus Maria Van Delden, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,065

(22) PCT Filed: Jan. 4, 2005
(86) PCT No.: PCT/IB05/50019

§ 371 Date: Jul. 10, 2006

(30) Foreign Application Priority Data
Feb. 5, 2004 (EP) 04100425.0
Jan. 15, 2004 (EP) 04100107.4

(51) Int. Cl. G02B 27/28

(52) U.S. Cl. 359/487

(57) ABSTRACT

A mirror device (1) which can be simultaneously used for display purposes based on e.g. an LCD display (5) with a polarizing mirror (2) placed in front of it. The orientation direction of a retardation layer (31, 32) is aligned with respect to the polarization direction of the polarizing mirror to give optimal optical performance.

The invention relates to a polarizing mirror for viewing purposes having a first plane reflecting light of a first kind of linear polarization to a viewing side, the mirror passing light of a second kind of linear polarization and being provided with a display device at its non-viewing side, which display device during use provides light of a second kind of linear polarization. A “mirror for viewing purposes” or “display mirror” in this application refers to a mirror, via which a person's eye (or an artificial eye like a (infra-red) camera lens) sees a reflected part of the outside world. As examples one may think of large mirrors, like bathroom mirrors, full-length mirrors in fitting rooms or even mirrored walls. Other examples are medium sized or small mirrors, like outside mirrors for trucks or dressing-table mirrors.

By “having a first plane reflecting light of a first kind of linear polarization” it is meant that a mirror plane acts as a polarizing plane. When in use, light within a certain range of a wavelength of light incident on a polarizing plane will be divided in two components one which is reflected by the polarizing plane and one of which passes through the polarizing plane. Generally most known is the division of light in two components having linearly polarized, perpendicular directions of linear polarization. In the examples of this particular application light is generally supposed to be divided in said linearly polarized, perpendicular directions of polarization, but the invention is equally applicable to light being divided in right-handed and left-handed circular polarization.

A display mirror of the kind mentioned above is described in the pending European Applications Serial number 02076069.2, filed on Mar. 18, 2002 and Serial number 02079306.3, filed on Oct. 17, 2002 (=PH NL 02.1038). The mirror function is obtained by introducing a polarizing mirror or reflective polarizer instead of a partly reflecting layer in front of a display device.

In practice it is not always possible or desirable to use displays and polarizing mirrors having their polarization directions aligned. Displays and mirrors to be combined usually have a variety of polarization directions (displays often 0, 45 or 90 degrees, mirrors often 0 or 90 degrees), which do not necessarily match. It is possible to use a larger polarizing mirror and cut out a part that matches the display in size and orientation. However, this greatly increases material cost, complicates the production process, reduces flexibility and limits the maximum size of display-mirror that can be obtained.

The invention has as its purpose to overcome said problems at least partly. According to the invention an optical film is provided between display and mirror that compensates for the difference in polarization direction. In general, this film consists of one or more retarders, e.g. half-lambda and quarter-lambda plates.

A half-lambda retarder is able to rotate the polarization direction, whereas a quarter-lambda retarder converts a circular polarization to a linear polarization and vice versa. It was found that in all cases the optical axis of the retarder should have a well-defined orientation. Conventional retarders have a retardation of a half lambda or a quarter lambda only for one wavelength (mostly 550 nm), whereas it is desired that they cover the whole visible range (400-700 nm). According to the invention (broad band) retarders are used which comprise a combination of several retarders at particular orientations.

In a preferred embodiment the display device and the polarizing mirror at its non-viewing side both comprise, a retardation layer such as a ¼λ foil, λ having a wavelength-value of e.g. 550±20 nm (narrow-band) or e.g. 550±255 nm (broad-band) The display can be moved freely, now and/or be rotated over any angle, with the rotation axis perpendicular to the surface of the display, between the polarizing mirror and the absorbing polarizer (within an enclosing light-shield) which is favorite in view of manufacturing tolerances.

If the absorbing polarizing layer comprises sub-layers absorbing light of the first kind of linear polarization and absorbing light of the second kind of linear polarization a very good display performance with optimum mirror performance is obtained.

In one embodiment at least one retardation layer is provided between the display device and the polarizing mirror, such as a retardation layer comprising at least one ½λ foil, λ having a wavelength-value of e.g. 550±30 nm (narrow-band) or e.g. 550±255 nm (broad-band).

These and other aspects of the invention are apparent from and will be elucidated with reference to the embodiments described hereinafter.

In the drawings:

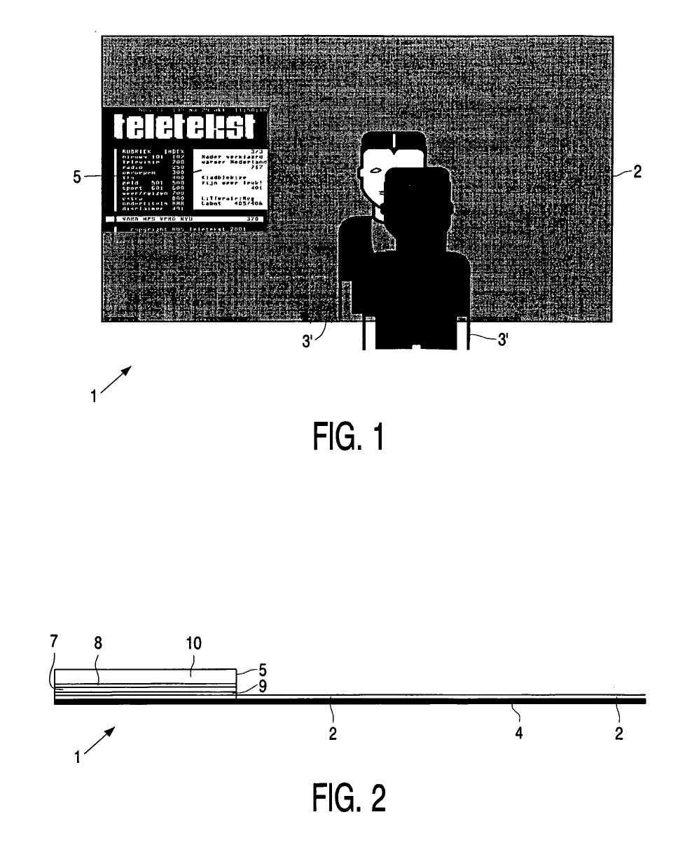

FIG. 1 is a possible embodiment of a mirror device according to the invention, while

FIG. 2 is a diagrammatic cross-section of a part of such a mirror device.

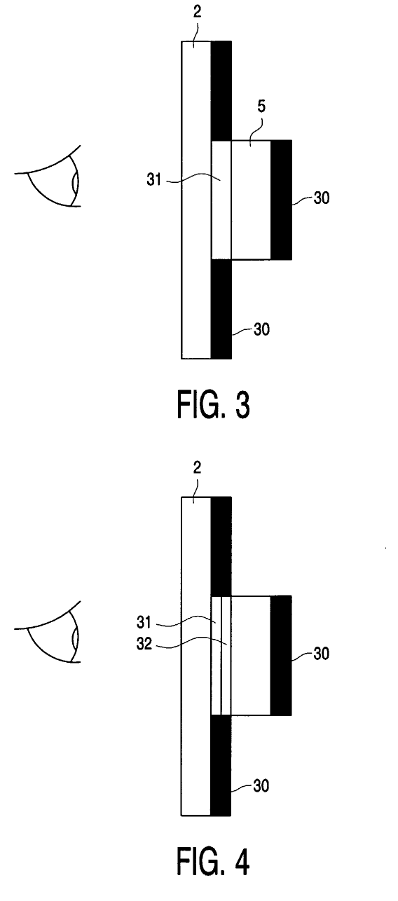

FIG. 3 is a diagrammatic cross-section of a part of a mirror device according to the invention,

FIG. 4 is a diagrammatic cross-section of a part of another mirror device according to the invention, while

The Figures are diagrammatic and not drawn to scale. Corresponding elements are generally denoted by the same reference numerals.

FIG. 1 shows a mirror device 1 for viewing purposes having on a glass plate or any other substrate 4 a polarizing mirror 2 reflecting light, so a person 3 sees his image 3′ (and further background, not shown). According to the invention the mirror (plane) only reflects light of a first kind of linear polarization (direction), but passes light of a second kind of linear polarization (direction). Furthermore the polarizing mirror is provided with a display device 5 at its non-viewing side (see also FIG. 2).

The display device 5 in this example is a liquid crystal display device having between two substrates (glass or plastic or any other suitable material) a liquid crystal material 7. Since most liquid crystal display devices are based on polarization effects the display 5 during use substantially emits polarized light. In general light from a backlight 10 is modulated by the liquid crystal display effect. Since the liquid crystal display device is based on a polarization effect the display 5 comprises a first polarizer 8 and a second polarizer (or analyzer) 9, which passes light of a certain polarization (direction).

This light of a certain polarization has the same (linear) polarization direction as the second kind of polarization (direction), so it passes the mirror (plane) 2 without any loss of light (100% transmission).

Since most liquid crystal display devices are based on modulation of linearly polarized light, linear polarizers 8, 9 are used, and the mirror 2 also is a linear polarization selective mirror e.g. a stack of dielectric layers, each layer having an optical thickness of one-quarter of a selected wavelength (or a mean value for a spectrum), while the layers have selected refractive indices or a wire-grid polarizer.

On the other hand in certain applications it may even be attractive to polarize light from e.g. an (O)LED or any other display to (linear or circular) polarized light to obtain the effect of a high contrast of displayed information with respect to reflected images in mirror applications.

In practice display devices and mirror devices are combined to a complete device, leading to the need of alignment. Moreover the polarization directions (displays often 0, 45 or 90 degrees, mirrors often 0 or 90 degrees) and not necessarily match. So one of either the mirror or the display substrate has to be rotated, leading to loss of material, especially at large area devices. A similar remark applies to the use of displays which emit non polarized light like (O)LED displays; now the polarization directions of the mirror and the extra polarizer have to be aligned.

In the embodiment of FIG. 3 this has been overcome by introducing a retarder, in this example a retarder layer (or polarization rotating foil ) 31, which rotates the polarization of the first kind. This implies that incident polarized light of the second kind, which passes the polarizing mirror 2, is rotated, but this does not affect the mirror function. Polarized light of the second kind as provided by the display device now passes both the foil 31 and the polarizing mirror 2. In this example a ½λ foil, having its orientation direction at 45 degrees with respect to the polarization direction of the polarizing mirror 2 is used, which may be a broad-band or a narrow-band foil. Now a display device 5 and a polarizing mirror 2 of substantially the same (large) size can be combined without losing expensive display or mirror area, at the cost of a cheap retarder layer 31. An absorbing polarizer 30 is applied at the back of the polarizing mirror 2.

In this example the ½λ foil has its orientation direction at 45 degrees with respect to the polarization direction of the polarizing mirror 2. Using such a single half-wave foil may introduce some discoloration of the transmitted image. The latter is overcome in the embodiment of FIG. 4, in which two ½λ foils 31, 32 are provided being aligned at an angle of about 45 degrees with respect to each other. In this example one half-lambda foil 31 has its orientation direction at 22.5 degrees with respect to the polarization direction of the polarizing mirror 2 and a second half-wave foil at 67.5 degrees with respect to the polarization direction of the polarizing mirror 2.

In another embodiment the foil 31 (FIG. 3) is a quarter-lambda retarder having its orientation direction at 45 degrees with respect to the polarization direction of the polarizing mirror 2, λ having a wavelength-value of e.g. 550±30 nm (narrow-band) or preferably 550±255 nm (broad-band). Also for the embodiment of FIG. 4 two such quarter-lambda retarders (plates) may be chosen.

The protective scope of the invention is not limited to the embodiments described. For instance, as mentioned, light from e.g. an (O)LED may be polarized or it may even be attractive to use other display effects to obtain the effect of a high contrast of displayed information with respect to reflected images in mirror applications.

More generally the embodiment of FIG. 3 is an example of a device according to the invention having the orientation direction of a retardation layer along the bisector of the polarization directions of the polarizing mirror and the display device, whereas the embodiment of FIG. 4 is an example of a device according to the invention having the orientation directions of a first and a second retardation layer along ¼α and ¾α in which a is the angle between the polarization directions of the polarizing mirror and the display device. In this example the first and a second retardation layers are ½λ foils.

Also more than one display can be integrated in the mirror, whereas many other applications areas can be thought of. In some applications, if a matrix form is used, with adequate driving circuitry the switching between mirror-state and display state can be done locally.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A polarizing mirror (1) for viewing purposes having a first plane (2) reflecting light of a first kind of polarization (20′) to a viewing side, the mirror passing light of a second kind of polarization (20″) and being provided with a display device (5) at its non-viewing side, which display device during use provides light of the second kind of polarization, at least one retardation layer (31,32) being provided between the display device and the polarizing mirror.

2. A polarizing mirror as claimed in claim 1, the orientation direction of a retardation layer (31,32) being at substantially 22.5 degrees or 45 degrees with respect to the polarization direction of the polarizing mirror.

3. A polarizing mirror as claimed in claim 1, at least two retardation layers (31,32) being provided between the display device and the polarizing mirror.

4. A polarizing mirror as claimed in claim 3, the absorbing polarizing layer and the polarizing mirror at its non-viewing side both comprising a retarder layer (35, 36), which rotates the polarization over substantially 45 degrees.

5. A polarizing mirror as claimed in claim 4, the orientation direction of the retardation layer (31,32) being at substantially 45 degrees with respect to the polarization direction of the polarizing mirror.

6. A polarizing mirror as claimed in claim 2, the retarder layer comprising a ¼λ foil.

7. A polarizing mirror as claimed in claim 3, having two retardation layer (31,32) between the display device and the polarizing mirror which each rotate the polarization over substantially 90 degrees.

8. A polarizing mirror as claimed in claim 3, having the orientation directions of a first and a second retardation layer along ¼α and ¾α a in which α is the angle between the polarization directions of the polarizing mirror and the display device

9. A polarizing mirror as claimed in claim 2, having the orientation direction of a retardation layer along the bisector of the polarization directions of the polarizing mirror and the display device.

10. A polarizing mirror as claimed in claim 7 the retardation layer comprising at least one ½λ foil.

11. A polarizing mirror as claimed in claim 1, at least one of the retarder layers being broad band retarders.
